(19) United States
(12) Patent Application Publication
(10) Pub. No.: US 2023/0063382 A1
(43) Pub. Date: Mar. 2, 2023

(54) SIGNATURE GENERATION DEVICE, SIGNATURE GENERATION METHOD, AND SIGNATURE GENERATION PROGRAM

(71) Applicant: NIPPON TELEGRAPH AND TELEPHONE CORPORATION, Tokyo (JP)

(72) Inventor: Yo KANEMOTO, Musashino-shi, Tokyo (JP)

(73) Assignee: NIPPON TELEGRAPH AND TELEPHONE CORPORATION, Tokyo (JP)

(21) Appl. No.: 17/795,886

(22) PCT Filed: Feb. 27, 2020
(86) PCT No.: PCT/JP2020/008176

§ 371 Date: Jul. 28, 2022

(51) Int. Cl. G06F 21/64

(52) U.S. Cl. CPC G06F 21/64

(57) ABSTRACT

A signature generation device includes processing circuitry configured to generate a PoC code candidate group of respectively different code contents using a PoC code, respectively execute the PoC code candidate group generated and acquire communication data regarding communication generated during execution, and generate a signature using the communication data acquired.

### TECHNICAL FIELD

The present invention relates to a signature generation device, a signature generation method and a signature generation program.

### BACKGROUND ART

Recently, new vulnerability has been found in an application operated on server software or a server, and a PoC (Proof of Concept) code that verifies the vulnerability has been disclosed.

In addition, in many products and OSS (Open Source Software), an attack is detected using a regular expression describing a feature of the attack called a signature. As a method of generating such a signature, the method of generating a signature from a PoC code by executing the PoC code by a symbolic execution engine is known (for example, see Non-Patent Literature 1).

### CITATION LIST

### Non-Patent Literature

Non-Patent Literature 1: Wang, Ruowen, et al. “MetaSymploit: Day-one defense against script-based attacks with security-enhanced symbolic analysis.” Presented as part of the 22nd USENIX Security Symposium (USENIX Security 13). 2013.

### SUMMARY OF THE INVENTION

### Technical Problem

However, in related art, since a signature is generated by executing a PoC code by a symbolic execution engine, the symbolic execution engine needs to be updated every time a PoC code execution environment is updated by change of a language specification and an execution environment, causing a problem of low maintainability.

### Means for Solving the Problem

In order to solve the problem described above and achieve an object, a signature generation device of the present invention includes: a candidate generation unit configured to generate a PoC code candidate group of respectively different code contents using a PoC code; an execution unit configured to respectively execute the PoC code candidate group generated by the candidate generation unit and acquire communication data regarding communication generated during execution; and a signature generation unit configured to generate a signature using the communication data acquired by the execution unit.

### Effects of the Invention

The present invention demonstrates an effect of being capable of creating a signature with high maintainability.

### BRIEF DESCRIPTION OF DRAWINGS

FIG. 1 is a diagram illustrating an example of a configuration of a signature generation device relating to a first embodiment.

FIG. 2 is a diagram describing an outline of processing by the signature generation device relating to the first embodiment.

FIG. 3 is a diagram illustrating an example of a PoC code.

FIG. 4 is a diagram describing a processing example of generating a PoC code candidate group.

FIG. 5 is a diagram illustrating an example of the PoC code candidate group generated from the PoC code.

FIG. 6 is a diagram illustrating an example of communication data.

FIG. 7 is a diagram illustrating an example of a generated signature.

FIG. 8 is a diagram illustrating an example of a normal request.

FIG. 9 is a flowchart illustrating an example of flow of processing in the signature generation device relating to the first embodiment.

FIG. 10 is a diagram illustrating a computer that executes a signature generation program.

### DESCRIPTION OF EMBODIMENTS

Hereinafter, the embodiment of a signature generation device, a signature generation method and a signature generation program relating to the present application will be described in detail based on the drawings. Note that the signature generation device, the signature generation method and the signature generation program relating to the present application are not limited by the embodiment.

[First embodiment] In the embodiment below, a configuration of a signature generation device 10 relating to the first embodiment and flow of processing of the signature generation device 10 are described in order, and an effect by the first embodiment will be described lastly.

[Configuration of Signature Generation Device]

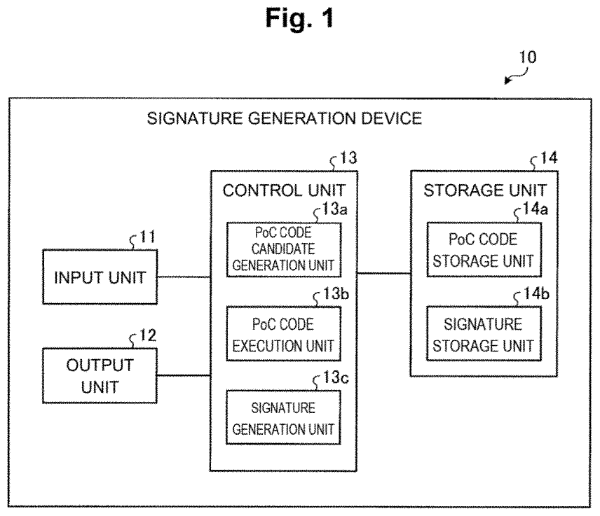

First, using FIG. 1, the configuration of the signature generation device 10 will be described. FIG. 1 is a diagram illustrating an example of the configuration of the signature generation device relating to the first embodiment. The signature generation device 10 automatically generates an expression called a signature for detecting an attack abusing a PoC code from the PoC code. As illustrated in FIG. 1, the signature generation device 10 includes an input unit 11, an output unit 12, a control unit 13 and a storage unit 14. Hereinafter, the respective units will be described.

The input unit 11 is realized using an input device such as a keyboard and a mouse, and inputs various kinds of instruction information of processing start or the like to the control unit 13 corresponding to an input operation by an operator. The output unit 12 is realized by a display device such as a liquid crystal display and a printing device such as a printer or the like.

The storage unit 14 is realized by a semiconductor memory device such as a RAM (Random Access Memory) and a flash memory, or a storage device such as a hard disk and an optical disk, and stores a processing program that operates the signature generation device 10 and data used during execution of the processing program or the like. The storage unit 14 includes a PoC code storage unit 14a and a signature storage unit 14b.

The PoC code storage unit 14a stores the PoC code to be used when a PoC code candidate group is generated by a PoC code candidate generation unit 13a to be described later. Note that the PoC code stored by the PoC code storage unit 14a may be stored beforehand, or the PoC code may be updated and added at any time. The signature storage unit 14b stores the signature generated by a signature generation unit 13c to be described later.

The control unit 13 includes an internal memory for storing a program that defines various kinds of processing procedures and required data, and executes various kinds of processing by them. For example, the control unit 13 is an electronic circuit such as a CPU (Central Processing Unit) and an MPU (Micro Processing Unit). The control unit 13 includes the PoC code candidate generation unit 13a, a PoC code execution unit 13b and signature generation unit 13c.

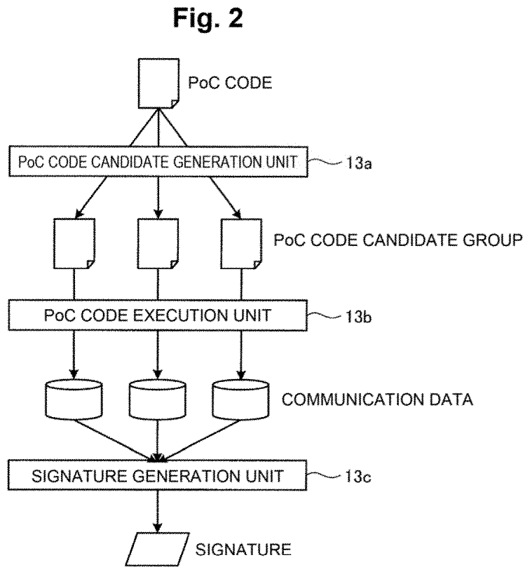

Here, before describing the respective units provided in the control unit 13, an outline of the entire processing by the signature generation device 10 will be described using FIG. 2. FIG. 2 is a diagram describing the outline of the processing by the signature generation device relating to the first embodiment. As illustrated in FIG. 2, first, the PoC code candidate generation unit 13a generates the PoC code candidate group of respectively different code contents using the PoC code. Then, the PoC code execution unit 13b respectively executes the PoC code candidate group, and acquires communication data regarding communication generated during the execution. Thereafter, the signature generation unit 13c generates the signature using the communication data.

In this way, the signature generation device 10 does not perform symbolic execution which lowers maintainability but executes the program of the PoC code as much as possible, and creates the signature from the communication data obtained at the time. Accordingly, since the signature generation device 10 executes a real PoC code and thus does not require an analyzer such as a symbolic execution engine which depends on a programming language of the PoC code, the maintainability is high. Hereinafter, the respective units provided in the control unit 13 will be described.

The PoC code candidate generation unit 13a generates the PoC code candidate group of the respectively different code contents using the PoC code. For example, the PoC code candidate generation unit 13a generates the PoC code candidate group by rewriting a conditional statement included in the PoC code. More specifically, the PoC code candidate generation unit 13a generates the PoC code candidate group by rewriting the conditional statement of a control structure such as “if”, “else” and “case” included in the PoC code.

Here, in order to recognize the control structure of the PoC code, the PoC code candidate generation unit 13a needs to perform syntax analysis to the programming language (such as Ruby and Python) utilized in the PoC code and convert a program code to an abstract syntax tree (AST). However, since a programming language execution environment includes a function of the syntax analysis in many cases, the PoC code candidate generation unit 13a does not need to originally create the abstract syntax tree and realization is possible by utilizing the existing function. That is, the programming language execution environment is provided in accordance with change of a language specification and an execution environment so that there is no need of preparation following the change on its own like the symbolic execution engine.

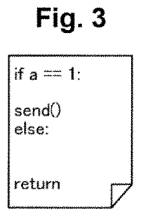

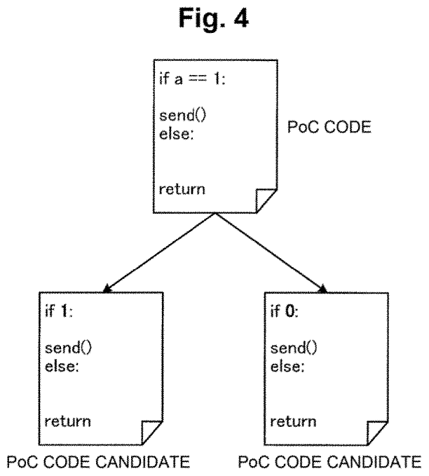

In addition, a reason for generating a plurality of PoC code candidates is to observe the substantial communication data of the PoC code. For example, in the case where there is a PoC code illustrated in FIG. 3, the communication is generated by a send( ) function when a variable “a” is 1, however, the communication is not generated so that the communication data by the send( ) function cannot be observed when “a” is other than 1. FIG. 3 is a diagram illustrating an example of the PoC code. For example, the PoC code candidate generation unit 13a generates, as illustrated in FIG. 4, the plurality of PoC codes from the PoC code illustrated in FIG. 3.

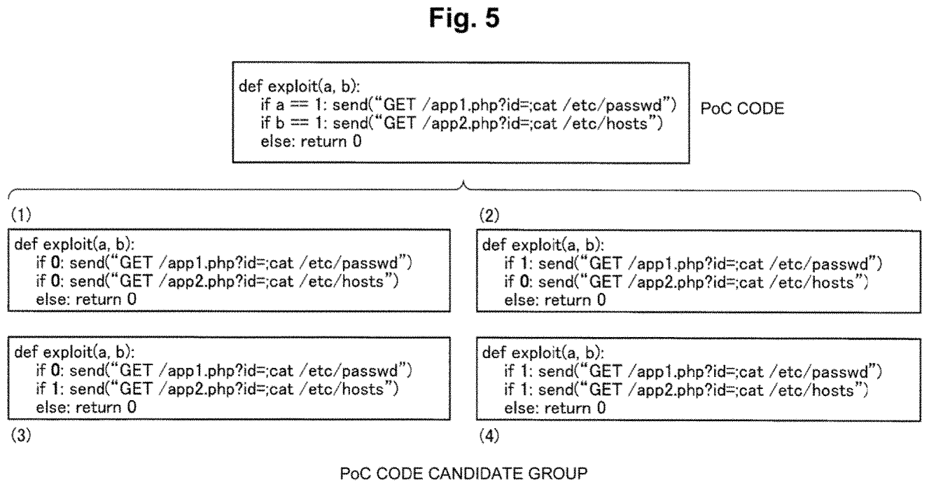

In addition, in an example in FIG. 5, the PoC code candidate generation unit 13a generates PoC code candidates (1)-(3) for which the conditional statement of “if” included in the PoC code is rewritten and a PoC code candidate (4) for which the conditional statement is as it is from the PoC code as the PoC code candidate group. FIG. 5 is a diagram illustrating an example of the PoC code candidate group generated from the PoC code.

The PoC code candidate generation unit 13a can pass through an execution path of the PoC code as much as possible when executing the PoC code by altering the control structure, and can observe more substantial communication data from the PoC code.

The PoC code execution unit 13b respectively executes the PoC code candidate group generated by the PoC code candidate generation unit 13a, and acquires the communication data regarding the communication generated during the execution. Specifically, the PoC code execution unit 13b executes the PoC code candidate group in a PoC code execution environment, observes the communication generated during the execution and acquires the communication data.

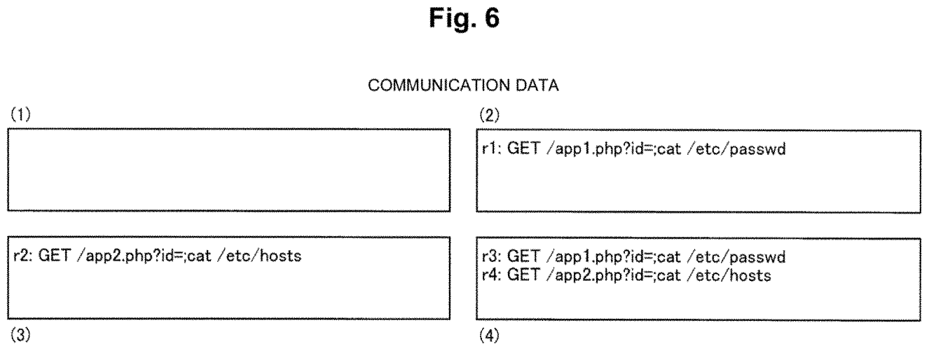

For example, the PoC code execution unit 13b acquires communication data (1)-(4) illustrated in FIG. 6 by respectively executing the PoC code candidates (1)-(4) illustrated in FIG. 5. FIG. 6 is a diagram illustrating an example of the communication data.

The signature generation unit 13c generates the signature using the communication data. For example, the signature generation unit 13c extracts a characteristic character string or byte string from a request to a server included in the communication data, converts the character string or the byte string to a regular expression and generates the signature.

More specifically, the signature generation unit 13c extracts the plurality of requests from the communication data, and defines the requests sorted in a descending order of length as R=(r1, r2 . . . ). Then, the signature generation unit 13c obtains a longest common substring C as C=LCS(LCS(r1, r2), r3) . . . LCS(X,y) is defined as in an expression (1) below for the byte string X=(x1, x2, . . . ), Y=(y1, Y2, . . . ). Then, the signature generation unit 13c corrects C to the regular expression, and defines the regular expression as a signature s.

[Math. 1]

$$L C S ( {X}_{i} , {Y}_{j} ) = \{ \begin{matrix}ϕ & if i = 0 or j = 0 \\ L C {S ( {X}_{i - 1} , {Y}_{j - 1} )}^{\hat{}} {x}_{i} & if i , j > 0 and {x}_{i} = {y}_{j} \\ max \{ L C S ( {X}_{i} , {Y}_{j - 1} ) , L C S ( {X}_{i - 1} , {Y}_{j} ) \} & if i , j > 0 and {x}_{i} \neq {y}_{j}\end{matrix} \qquad ( 1 )$$

The case where the signature generation unit 13c expresses the signature as the regular expression has been described above. Note that, since there are various signature expression methods depending on an attack detection tool, generation may be performed by the signature expression method suited to the attack detection tool, and a signature expression is not limited to the regular expression.

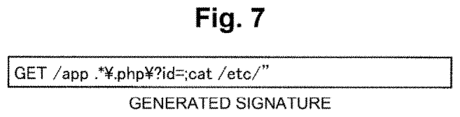

Here, the case of generating the signature from the communication data illustrated in FIG. 6 will be described. The signature generation unit 13c obtains the longest common substring C=LCS(LCS(LCS(r1, r2), r3), r4) of requests r1, r2, r3 and r4 extracted from the communication data observed by PoC code execution. In the case of FIG. 6, it is C=(“GET/app”,“.php?id=;cat/etc/”). The signature generation unit 13c escapes a special symbol utilized in the regular expression for C, then couples the common substring by “.*” indicating a plurality of arbitrary character strings, and obtains one regular expression. It is defined as the signature s. In the above case, C after escape is C=(“GET/app”,“Y.phpY?id=;cat/etc/”) and the signature s is s=“GET/app.*Y.phpY?id=;cat/etc/.*” as illustrated in FIG. 7.

In addition, the signature generation unit 13c may extract the characteristic character string or byte string from the request to the server included in the communication data, exclude an element included in a normal request from the character string or the byte string and generate the signature.

That is, in order to reduce erroneous detection that the generated signature detects normal communication, in the signature generation unit 13c, after the longest common substring C=(c1, c2, . . . ) is extracted from a request group R, for respective elements c1, c2, . . . of C, the relevant individual elements are excluded in the case of being included in a normal request group observed beforehand.

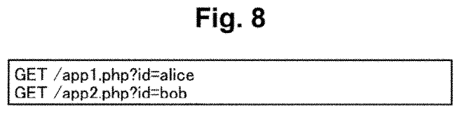

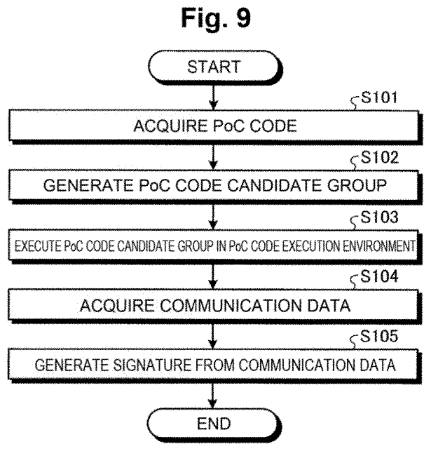

As a specific example, it is assumed that C=(“GET/app”,“.php?id=;cat/etc/”) is obtained as the longest common substring similarly to the above description, and the normal request observed beforehand is the normal request illustrated in FIG. 8, for example. In such a case, the signature generation unit 13c excludes the character string “GET/app” which is the element of C since it is included in the normal request, and does not exclude the character string “.php?id=;cat/etc/” which is the element of C since it is not included in the normal request. Therefore, it is C=(“.php?id=;cat/etc/”) and the signature generation unit 13c obtains the signature s=(“Y.phpY?id=;cat/etc/”) after the escape.

[Processing procedure of signature generation device] Next, an example of the processing procedure by the signature generation device 10 relating to the first embodiment will be described using FIG. 9. FIG. 9 is a flowchart illustrating an example of flow of the processing in the signature generation device relating to the first embodiment.

As illustrated in FIG. 9, the PoC code candidate generation unit 13a of the signature generation device 10 acquires the PoC code from the PoC code storage unit 14a (step S101), and generates the PoC code candidate group of the respectively different code contents using the PoC code (step S102). For example, the PoC code candidate generation unit 13a generates the PoC code candidate group by rewriting the conditional statement included in the PoC code.

Then, the PoC code execution unit 13b executes the PoC code candidate group in the PoC code execution environment (step S103), observes the communication generated during the execution and acquires the communication data (step S104).

The signature generation unit 13c generates the signature from the communication data (step S105). For example, the signature generation unit 13c extracts the characteristic character string or byte string from the request to the server included in the communication data, converts the character string or the byte string to the regular expression and generates the signature.

[Effects of first embodiment] In such a manner, the signature generation device 10 relating to the first embodiment generates the PoC code candidate group of the respectively different code contents using the PoC code, respectively executes the PoC code candidate group, acquires the communication data regarding the communication generated during the execution, and generates the signature using the communication data. Thus, the signature generation device 10 can create the signature with high maintainability.

That is, in the signature generation device 10, a part depending on the PoC code execution environment is reduced, and the signature with the high maintainability to be easily maintained and managed can be generated. Therefore, in the signature generation device 10, for the PoC code written in various programming languages, the signature for detecting an attack performed by abusing the PoC code can be continuously generated.

[System configuration or the like] In addition, illustrated individual components of the individual devices are under the concept of functions and do not necessarily need to be physically configured as illustrated. That is, a specific form of distribution/integration of the individual devices is not limited to the illustration, and all or part of them can be functionally or physically distributed/integrated in arbitrary units according to various kinds of loads and using situations or the like. Further, all or arbitrary part of individual processing functions performed in the individual devices may be realized by a CPU and a program analyzed and executed in the CPU or realized as hardware by wired logic.

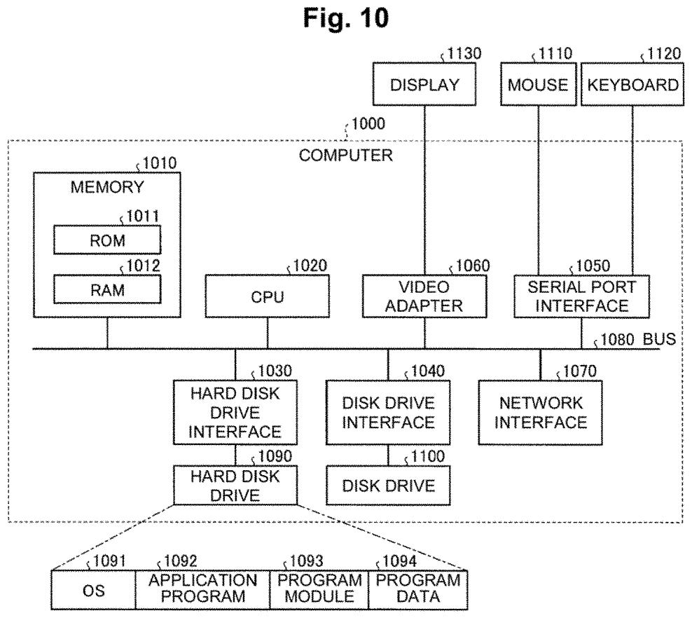

Further, of the individual processing described in the present embodiment, all or part of the processing described as the one to be automatically performed may be manually performed, or all or part of the processing described as the one to be manually performed may be automatically performed by a known method. In addition, information including the processing procedure, a control procedure, specific names and various kinds of data and parameters illustrated in the document and in the drawings described above may be arbitrarily changed except unless otherwise specified.

[Program] FIG. 10 is a diagram illustrating a computer that executes the signature generation program. A computer 1000 includes a memory 1010 and a CPU 1020, for example. In addition, the computer 1000 includes a hard disk drive interface 1030, a disk drive interface 1040, a serial port interface 1050, a video adapter 1060 and a network interface 1070. The individual units are connected by a bus 1080.

The memory 1010 includes a ROM (Read Only Memory) 1011 and a RAM 1012. The ROM 1011 stores a boot program of a BIOS (Basic Input Output System) or the like, for example. The hard disk drive interface 1030 is connected to a hard disk drive 1090. The disk drive interface 1040 is connected to a disk drive 1100. A detachable storage medium such as a magnetic disk and an optical disk is inserted to the disk drive 1100. The serial port interface 1050 is connected to a mouse 1051 and a keyboard 1052, for example. The video adapter 1060 is connected to a display 1061, for example.

The hard disk drive 1090 stores an OS 1091, an application program 1092, a program module 1093 and program data 1094, for example. That is, the program that defines the individual processing of the signature generation device is mounted as the program module 1093 describing codes that are executable by the computer. The program module 1093 is stored in the hard disk drive 1090 for example. For example, the program module 1093 for executing the processing similar to the functional configuration in the device is stored in the hard disk drive 1090. Note that the hard disk drive 1090 may be substituted by an SSD (Solid State Drive).

In addition, the data used in the processing in the embodiment described above is stored in the memory 1010 or the hard disk drive 1090 for example, as the program data 1094. Then, the CPU 1020 reads the program module 1093 and the program data 1094 stored in the memory 1010 or the hard disk drive 1090 to the RAM 1012 as needed and executes them.

Note that the program module 1093 and the program data 1094 are not limited to the case of being stored in the hard disk drive 1090, and may be stored in the detachable storage medium for example and read by the CPU 1020 via the disk drive 1100 or the like. Or, the program module 1093 and the program data 1094 may be stored in another computer connected via a network or a WAN. Then, the program module 1093 and the program data 1094 may be read from another computer by the CPU 1020 via the network interface 1070.

### REFERENCE SIGNS LIST

10 Signature generation device
11 Input unit
12 Output unit
13 Control unit
13a PoC code candidate generation unit
13b PoC code execution unit
13c Signature generation unit
14 Storage unit
14a PoC code storage unit
14b Signature storage unit

1. A signature generation device comprising:
processing circuitry configured to:
generate a PoC code candidate group of respectively different code contents using a PoC code;
respectively execute the PoC code candidate group generated and acquire communication data regarding communication generated during execution; and
generate a signature using the communication data acquired.

2. The signature generation device according to claim 1, wherein the processing circuitry is further configured to generate the PoC code candidate group by rewriting a conditional statement included in the PoC code.

3. The signature generation device according to claim 1, wherein the processing circuitry is further configured to execute the PoC code candidate group in a PoC code execution environment, observe the communication generated during the execution and acquire the communication data.

4. The signature generation device according to claim 1, wherein the processing circuitry is further configured to extract a characteristic character string or byte string from a request to a server included in the communication data, convert the character string or the byte string to a regular expression and generate the signature.

5. The signature generation device according to claim 1, wherein the processing circuitry is further configured to extract a characteristic character string or byte string from a request to a server included in the communication data, exclude an element included in a normal request from the character string or the byte string and generate the signature.

6. A signature generation method executed by a signature generation device, the signature generation method comprising:
generating a PoC code candidate group of respectively different code contents using a PoC code;
respectively executing the PoC code candidate group generated and acquiring communication data regarding communication generated during execution; and
generating a signature using the communication data acquired.

7. A non-transitory computer-readable recording medium storing therein a signature generation program that causes a computer to execute a process comprising:
generating a PoC code candidate group of respectively different code contents using a PoC code;
respectively executing the PoC code candidate group generated and acquiring communication data regarding communication generated during execution; and
generating a signature using the communication data acquired.
